(19) United States
(12) Patent Application Publication
(10) Pub. No.: US 2023/0034921 A1
(43) Pub. Date: Feb. 2, 2023

(54) DETECTION OF A REWIND ATTACH AGAINST A SECURE ENCLAVE

(71) Applicant: R3 Ltd., London (GB)

(72) Inventors: Michael Christopher Hearn, London (GB); Richard G. Brown, London (GB)

(21) Appl. No.: 17/938,381

(22) Filed: Oct. 6, 2022

Related U.S. Application Data
(62) Division of application No. 16/847,749, filed on Apr. 14, 2020.

(51) Int. Cl. G06F 21/53; G06F 21/56; G06F 21/60

(52) U.S. Cl. CPC G06F 21/53; G06F 21/566; G06F 21/602; G06F 2221/033; G06Q 10/107

(57) ABSTRACT

A system is provided for detecting whether an application program executing in a secure enclave of a host computing system may be the target of a rewind attack. The system ensures that state information is consistent with messages that are received. The messages contain current ordering information, previous ordering information, and a related message identifier. When a message is received, the system determines whether the previous ordering information of the message and previous ordering information of the state information associated with the related message identifier are consistent. If not consistent, the system may indicate that a rewind attack is in progress because a malicious actor may have provided an out-of-date version of the state information. If consistent, the system updates previous ordering information of the state information that is associated with the related message identifier based on the current ordering information.

### CROSS-REFERENCE TO RELATED APPLICATION

This application is a divisional of U.S. patent application Ser. No. 16/847,749 filed on Apr. 14, 2020, which is hereby incorporated by reference in its entirety

### BACKGROUND

Application programs store application information in storage that later needs to be retrieved. The application information that is stored represents the current version of the application information. When the application information is later retrieved by the application program, the application program can continue its execution with that application information. For example, an application program may receive messages from multiple client systems and store those messages in storage. The application program may need to perform computations based on those messages and store the results of the computations for later processing when a subsequent message is received. For example, companies that sell commodities may send pricing information to an organization that publishes commodity indices. When a message with pricing information for a commodity is received by the organization, the organization stores the pricing information and eventually calculates an index for the commodity from that pricing information. The application program of the organization stores the pricing information in an encrypted form and persistently in storage. To calculate the index, the application program retrieves the pricing information from storage, decrypts the pricing information, and calculates the index.

If the application program needs to restart execution, it may lose its current state (e.g., memory is cleared). In such a case, the application program may need to rely on application information that has been stored persistently. After restart, the application program retrieves the application information and continues execution.

Unfortunately, a malicious actor may attempt to mount a “rewind” attack against the application program. A malicious actor (e.g., computer code) may intercept and store the application information each time it is updated by the application program. The malicious actor thus maintains multiple prior “snapshots” of the application information. When the application program restarts and retrieves its application information, the malicious actor may provide a snapshot of the application information that is not the most current. When the application program does not maintain state across restarts, the application program may not be able to detect that it has been provided application information that is not the most current, which can present problems. For example, an organization that publishes a commodity index may, after restart, receive some pricing information and then decide to calculate an index based on that new pricing information and the pricing information previously received. If the application program is provided a snapshot of the application information that is not the most current, the application program will calculate the index using some out-of-date information and publish an index that is not accurate. Such an attempt by a malicious actor to provide a snapshot that is not the most current is referred to as a “rewind” attack because the application information is effectively rewound to a prior time. Since the application information is stored in encrypted form, the malicious actor cannot alter the information but can nevertheless provide encrypted, out-of-date application information as a rewind attack. In addition, a malicious actor may also intercept messages sent to the application program and store them and resend them at a later time to effectively replay the messages. Such replaying may allow the malicious actor to determine the content of a message to which the malicious actor is not authorized to access.

### BRIEF DESCRIPTION OF THE DRAWINGS

FIG. 1 is a block diagram that illustrates an SERW environment.

FIG. 2 is a flow diagram that illustrates the processing of a verify message component of the SED system in some embodiments.

FIG. 3 is a flow diagram that illustrates the processing of a perform verification component of the SERW system in some embodiments.

FIG. 4 is a flow diagram that illustrates the processing of an update POI table component of the SERW system in some embodiments.

### DETAILED DESCRIPTION

A method and system are provided for verifying whether state information retrieved from storage is consistent with data that is received from clients (“client data”) and/or represents a version of the state information that is not current. In some embodiments, a secure enclave (“SE”) application executing in a secure enclave may employ a secure enclave rewind (“SERW”) system to help detect rewind attacks by a host computer system that hosts the secure enclave. The SERW system helps ensure that a rewind attack by a malicious actor of a host computing system can rewind only to state information that is consistent with replayed client data. The SERW system can also detect that the state information is possibly not current in some instances. As used herein, the term “application” refers to a computer program that may conventionally be referred to as either an application program or a system program.

The SERW system can verify whether client data and state information provided by the host computing system are consistent or inconsistent and/or whether state information is not current. If inconsistent or not current, then the SERW system notifies the SE application so that appropriate countermeasures can be taken. The inconsistency may be a result of, for example, a malicious actor (e.g., the host computing system or a client) (1) providing state information that is an out-of-date version of the state information (e.g., a rewind attack), (2) replaying client data that is already reflected in the state information (i.e., old client data), or (3) providing client data that indicates that not all prior client data is reflected in the state information, referred to as a “gap” in client data.

The state information may not be current when there is a gap in client data. A gap a occurs, for example, when a malicious actor provides current state information to the SE application but fails to provide client data received from a client between 1:00 am to 5:00 am and then provides client data received from that client after 5:00 am. The client data received after 5:00 am would indicate that not all client data has been provided, that is, there is a gap in the client data. As another example, a gap occurs when a malicious actor provides old state information that was current at 1:00 am yesterday and replays the client data from 5:00 am yesterday without replaying the client data from 1:00 am to 5:00 am yesterday. As another example, a gap may occur even though the state information is current as a result of a malicious client sending client data that indicates some prior client data was not sent or a result of technical problems (e.g., non-delivery of client data, a bug in a client application).

When a gap occurs, the SERW system cannot definitively determine whether the state information provided by the host computing system was current or not current. The SERW system can, however, apply heuristics to effectively make an educated guess as to whether the state information is possibly current or possibly not current. For example, the heuristic may be based on whether the host computing system or clients appears to be malicious. If gaps occur in the client data of only a small percent of clients, then those clients may be malicious and the state information is possibly current. If, however, gaps occur in the client data of a large percent of clients, then since it is unlikely that so many clients are malicious, the state information is possibly not current. The SERW system may employ a not current threshold to distinguish between the state information being possibly current or possibly not current. For example, the threshold may be based on the number or portion (e.g., >2%) of clients who sent gap client data or the amount of gap client data (e.g., received messages). When the not current threshold is satisfied, the state information may be characterized as possibly not current and may also have an associated confidence based on the amount of gap client data.

The SERW system can effectively “store” the state information by directing the host computing system to store an encrypted version of the state information or storing an encrypted version of the state information in a message that the SERW system sends to itself. The SERW system may periodically store current state information of the SE application to help ensure that the stored current state information represents current state information at a relatively recent time before execution of the SE application halts. After a restart, the host computing system provides an encrypted version of the state information that should be the current state information that was last stored by the SERW system. In addition, the host computing system provides client data that should be the client data received since the SE application halted execution. The SERW system decrypts the state information and provides the state information to the SE application. The SERW system then ensures that client data provided by host computing system and the state information are consistent. Thus, the SERW system defends against attacks perpetrated by a malicious actor such as replaying of client data, failing to provide client data (e.g., leaving gaps), rewinding of state information, and so on.

In some embodiments, the client data includes ordering information, and the state information includes previous ordering information for each client. The SERW system ensures that the previous ordering information of client data for a client and previous ordering information of the state information for that client are consistent. When they are consistent, the SE application can process the client data based on the state information. If they are not consistent, an attack may be being attempted and the SE application can take countermeasures, such as shutting down or sending a notification to a trusted authority.

In some embodiments, when the secure enclave is provided a current message (i.e., current client data) by the host computing system, the SERW system verifies that the current message and the state information of the SE application are consistent. The current message includes ordering information and a related message identifier. The messages provided secure enclave may be, for example, emails or posts. The related message identifiers may be, for example, the sender of a message or topic of the message. The ordering information may be unique message identifiers (e.g., time of previous email, sequence number, or hash of an email) that uniquely identify each message associated with a related message identifier. The SERW system stores the messages in storage controlled by the host and may maintain a previous ordering information (“POI”) data structure (as part of the state information) that maps related message identifiers to previous ordering information associated with the related message identifiers. For example, the POI data structure may be a table that maps sender identifiers to the time of the last email (e.g., sent time that is included in the email) received from the identified sender.

In some embodiments, the SERW system may employ implicit or explicit ordering information. Ordering information is implicit when ordering information of a previous message can be determined from ordering information of a current message. For example, if the messages are numbered sequentially by the sender, then the message number of the previous message (i.e., previous ordering information) can be determined from the message number of the current message. Ordering information is explicit when the current message contains both the current ordering information of the current message and the current ordering information of the previous message (i.e., previous ordering information). For example, if the messages are time-stamped, then the current message may contain the time of the current message and the time of the previous message.

Upon receiving a message, the SERW system may decrypt the message and extract the related message identifier and the ordering information, which may include current ordering information and previous ordering information. The SERW system retrieves from a POI table the previous ordering information that is associated with the related message identifier. The SERW system then decrypts the previous ordering information and determines whether the previous ordering information from the POI table is consistent with the ordering information of the message. If they are not consistent, then the host computing system may be malicious by rewinding state information, replaying messages, and so on. If they are consistent, the SERW system may re-encrypt the message and store the re-encrypted message in SE storage and update the POI table so that the current ordering information stored as the now-previous ordering information associated with the related message identifier. The SERW system may decrypt messages using a private key (e.g., of the secure enclave or the SERW system) and encrypt and decrypt data stored in SE storage using public/private key pairs or symmetric keys. The SERW system may use the public key associated with a sender of a message (or message identifier) to ensure that the message was signed by the sender. Alternatively, the SE application may be responsible for the encryption and decryption. Some secure enclaves may automatically encrypt and decrypt data sent to and received from SE storage.

In some embodiments, the SERW system effectively stores state information (e.g., the POI table) persistently for the SE application. When the SE application wants to maintain state information persistently (e.g., across restarts), the SERW system encrypts a state message that includes the state information and sends the state message to itself. For example, the SERW system may send the state message to a third party (e.g., a client) who later sends the state message for delivery to the SERW system or sends the state message directly to itself. The SERW system may send a state message with state information that is specific to a client to the client. The client can then send the state information to the SERW system along with a client message. When the state message is received (e.g., after restart), the SERW system decrypts the state message to retrieve the state information. The SE application may employ the SERW system as a checkpointing service. To create a checkpoint, the SERW system sends a state message. When state messages are delivered (e.g., after a restart), the SERW system may process the state messages until one is processed with previous ordering information that is consistent with the previous ordering information of the POI table. The SERW system may send a state message with state information that is specific to a client to that client so that the client can then send the state information to the SERW system. Upon receiving state information from a client, the SERW system will know that the state information is for the sending client. The SERW may also include a hash of the messages stored in the SE storage in the state messages to confirm that the state information is consistent with those messages—those messages may be subject to a rewind attack by the host computing system.

In some embodiments, the SERW system may encrypt and store state information in SE storage rather than include the state information in a state message. When the SERW application stores the state information, the SERW system may store previous ordering information in the POI table and send a state message with the previous ordering information. When the SE application receives a state message, the SERW system ensures that the previous ordering information of the state message is consistent with the previous ordering information of the POI table. If they are consistent, the SE application may assume that state information of the SE storage is valid state information—albeit possibly not the most current state information stored by the SE application because of an attempted rewind attack.

In some embodiments, an SE application may handle messages associated with millions of different message identifiers (e.g., cell phone numbers). The overhead in maintaining a POI table with millions of records may be prohibitive. To help lessen the overhead, the SERW system may store previous ordering information for only a subset (e.g., 10%) of the related message identifiers. When only a subset is stored, the detection of an attempted rewind attack may be delayed until a message associated with a message identifier in the subset is received. But, depending on the type of data processed by the SE application, the delayed detection may be acceptable.

In some embodiments, an SE application may assume that clients that send messages are trusted in the sense that they will correctly identify the previous ordering information. However, if a client is malicious and sends incorrect ordering information in a message, the SERW system may incorrectly assume that the host computing system is malicious. The SE application may implement a malicious host criterion to determine whether the host computing system or a client is malicious. For example, the malicious host criterion may be satisfied when inconsistent ordering information has been received from a certain percentage (e.g., 2.0%) of the clients. If the malicious host criterion is satisfied, the SE application may assume that the host computing system is malicious by providing rewound state information or replaying messages. If the criterion is not satisfied, the SE application may assume that any inconsistent ordering information is caused by a malicious client. The malicious host criterion may be based on a rolling time window so that infrequent instances of inconsistent ordering information resulting from malicious or malfunctioning client systems do not accumulate over time to satisfy the malicious host criterion.

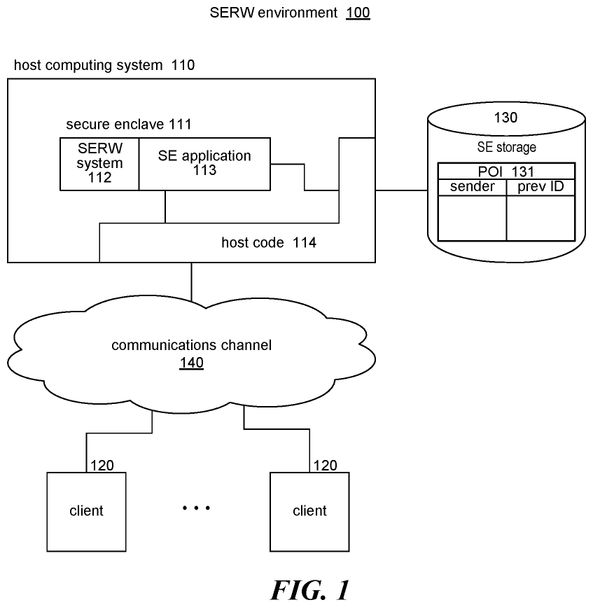

FIG. 1 is a diagram that illustrates an SERW environment. In some embodiments, an SERW environment 100 includes a host computing system 110, client systems 120, SE storage 130, and a communications channel 140. The host computing system includes a secure enclave 111 and host code 114 that may be malicious. An SERW system 112 and an SE application 113 execute within the secure enclave environment. The client systems communicate with the host computing system via the communications channel. The host code receives encrypted client data from the client systems and encrypted application data (e.g., emails) from the SE storage and provides the encrypted data to the SE application, and it receives encrypted application data from the SE application and stores the encrypted application data to the SE storage. The SE storage stores SE application data and state information that includes the POI table 131, which contains a record for each sender and the previous ordering information of the sender. The SE storage may be any type of persistent storage. Rather than being stored in SE storage, the state information may alternatively be stored in a state message that the SE application sends to itself.

In some embodiments, the code of the SERW system may be part of the SE application (e.g., within executable code of the SE application) or a separate service provided to the application. In addition, some of the functions of the SERW system may be implemented as part of the application and other functions may be provided by the separate service. For example, the host computing system may provide messages directly to the SE application, and the SE application may invoke components of the separate service to verify that the messages and state information are consistent. Alternatively, the host computing may provide messages directly to the SERW system as a separate service which verifies the messages and provides them to the SE application.

The term “secure enclave” refers to a feature of a central processing unit (“CPU”) in which code and data of code (i.e., trusted code) are stored in external memory or persistent storage) in encrypted form and decrypted only when retrieved for use by the CPU. Such code is said to execute in the secure enclave. A secure enclave has internal memory that is used by code executing within the secure enclave to store its data that includes its state. The internal memory is, however, not persistent. So, when the secure enclave halts execution (e.g., host computing system is rebooted), the state stored in the internal memory is lost. So, when the secure enclave restarts execution, the internal memory no longer stores the state. Thus, the code needs to retrieve its state from an external source to resume execution based on the state of the code when execution of the secure enclave halted.

To ensure that the code executing in a secure enclave is trusted code (e.g., the code that is expected), the CPU supports generating an attestation of the trusted code (e.g., the SE application and the SERW system) that executes in the secure enclave. The attestation includes a hash of the trusted code, an identifier of the CPU, and application data. The attestation is encrypted or signed by a CPU private key of a CPU public/private key pair that is stored in the CPU during manufacture of the CPU. The trusted code requests the CPU to provide the attestation and then provides the attestation to client code as evidence of the trusted code that executes in the secure enclave. The client code can request a service (of the manufacturer of the CPU) to provide the CPU public key of the CPU public/private key pair to decrypt or verify the signature. The client code can extract the hash to verify that the trusted code is the expected code and extract the application data. Such a secure enclave is provided by the Software Guard Extensions (“SGX”) feature provided by Intel Corporation.

Application data of an application that is executing within a secure enclave is encrypted before being stored in storage and decrypted when retrieved from storage. In addition, client data (e.g., messages) received from client systems is encrypted and decrypted after being received. Similarly, data sent to client systems is encrypted and then decrypted by the client system. The data is considered to be stored in an encrypted form. The data can be encrypted and decrypted either by the application or the secure enclave environment provided by the hot computing system. When data is described without the adjective “decrypted” or “encrypted,” it is considered to be in an unencrypted form whether decrypted from encrypted data or created in an unencrypted form.

The computing systems (e.g., nodes) on which the SERW system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the SERW system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SERW system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the SERW system may be implemented in hardware using, for example, an application-specific integrated circuit (ASIC) or field programmable gate array (“FPGA”).

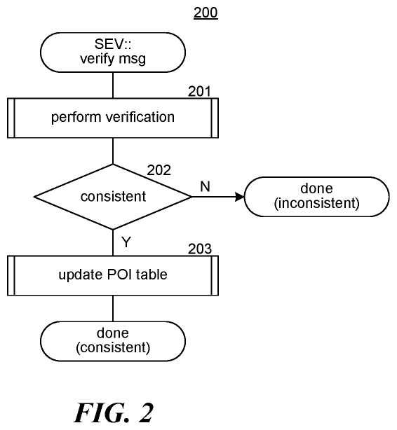

FIG. 2 is a flow diagram that illustrates the processing of a check consistency component of the SERW system in some embodiments. The check consistency component 200 is invoked by the SE application to verify whether state information and a current message are consistent by checking whether the current message is the correct next message. In block 201, the component invokes a perform verification component to verify that the previous ordering information of the current message and the previous ordering information of the POI table indicate a correct ordering. In decision block 202, if the ordering has been verified as correct, then the component continues at block 203, else the component completes indicating that the state information and the current message are inconsistent. In block 203, the component invokes an update POI table component to update the POI table with the previous ordering information based on current message. The component then completes indicating that the state information and the current message are consistent.

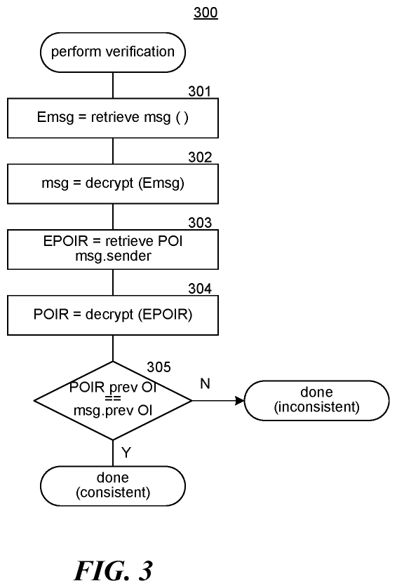

FIG. 3 is a flow diagram that illustrates the processing of a verify ordering component of the SERW system in some embodiments. The verify ordering component 300 is invoked to verify that the ordering of current message and the previous message based on the ordering information of the current message and previous ordering information of the POI table. In block 301, the component retrieves the encrypted current message. In block 302, the component decrypts the encrypted current message. In block 303, the component retrieves from the POI table the record (“POIR”) for the sender of the current message. In block 304, the component decrypts the encrypted record. In decision block 305, if the previous ordering information of the record and the ordering information of the current message indicates a correct ordering, then the component completes indicating that the ordering is correct, else the component completes indicating that the ordering is not correct.

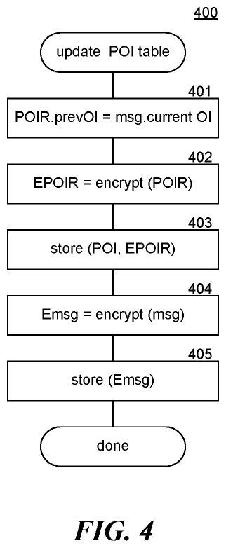

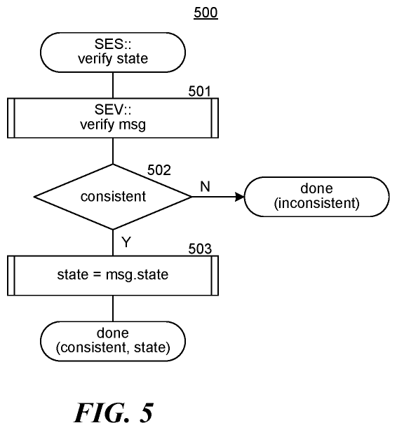

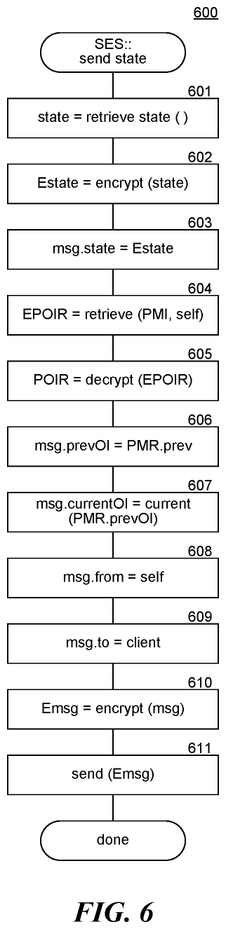

FIG. 4 is a flow diagram that illustrates the processing of an update POI table component of the SERW system in some embodiments. The update POI table component 400 is invoked to update a record in the POI table for a sender (i.e., client) with new previous ordering information. In block 401, the component sets the previous ordering information of the record based on ordering information of the current message. In block 402, the component encrypts the record. In block 403, the component stores in the POI table the encrypted record. In block 404, the component encrypts the current message. In block 405, the component stores the encrypted current message in the secure enclave storage or internal memory to be part of a state message and then completes.

The computing systems (e.g., nodes) on which the SERW system may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the SERW system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The SERW system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various embodiments. Aspects of the SERW system may be implemented in hardware using, for example, an application-specific integrated circuit (ASIC) or field programmable gate array (“FPGA”).

A method performed within a secure enclave of a host computing system that is executing an application is provided to determine whether application information of the application and client data provided to the secure enclave by the host computing system are consistent. The method accesses encrypted client data provided by the host computing system. The encrypted client data includes ordering information and a related data identifier. The method decrypts the encrypted client data. The method accesses encrypted application information provided by the host computing system. The encrypted application information includes previous ordering information that is associated with the related data identifier. The method decrypts the encrypted application information. The method determines whether the ordering information and the previous ordering information indicates an ordering that is correct. The method indicates that the application information and the client data are not consistent based on the determination. In some embodiments, when the ordering information and the previous ordering information or determined to be correct, the method updates the application information to have new previous ordering information associated with the related data identifier. The new previous ordering information is based on the ordering information. In some embodiments, the new previous ordering information is stored in a previous ordering information data structure that includes previous ordering information for each of multiple related data identifiers. In some embodiments, the method further stores of the client data in encrypted form in persistent storage. In some embodiments, when the ordering information and the previous ordering information are determined to be not correct, the method indicates that the client data and the application information are inconsistent. In some embodiments, the client data is a message and the related data identifier is based on a sender of the message. In some embodiments, the related data identifier is based on a topic associated with the client data. In some embodiments, the client data includes current ordering information and previous ordering information and the determining is based on the current ordering information of the client data and the previous ordering information of the application information. In some embodiments, the client data includes current ordering information and the determining is based on the current ordering information and the previous ordering information.

In some embodiments, a method performed within a secure enclave of a computing system is provided for detecting whether stored information stored in storage is inconsistent with a message. The method accesses a message that is received by the secure enclave. The message includes current ordering information, previous ordering information, and a related message identifier. The message is received in an encrypted form and decrypted. The method accesses a previous ordering information data structure that includes, for each of multiple related message identifiers, previous ordering information associated with that related message identifier. The previous ordering information is stored in an encrypted form. The method indicates whether the accessed previous ordering information and the stored information are consistent with the stored information based on the previous ordering information of the message and the previous ordering information data structure. In some embodiments, when the previous ordering information and the stored information are consistent, the method stores new previous ordering information in association with the related message identifier of the message. In some embodiments, the new previous ordering information is stored in a previous ordering information data structure that includes previous ordering information for each of multiple related message identifiers. In some embodiments, the related message identifier is unique to a sender of the message. In some embodiments, the related message identifier is based on a topic associated with the message.

In some embodiments, a method performed in a secure enclave environment of a host computing system is provided for persisting state information of an application. The method encrypts a state message that includes the state information. The method directs the host computing system to send the encrypted state message to the application. The method, after execution of the application halts and is restarted, receives from the host computing system the encrypted state message. The method decrypts the encrypted state message. The method initializes state information of the executing application to the state information of the decrypted state information. In some embodiments, the state message includes an application identifier that identifies the application. In some embodiments, the state message is sent to a client system and the client system then sends a message with the state information to the application. In some embodiments, the method, after a client message is received from a client, determines whether the state information and the client message are consistent based on ordering information of the client message and previous ordering information of the state information. In some embodiments, the state message is sent to create a checkpoint for the application.

In some embodiments, a method performed by a secure enclave of a host computing system is provided for determining with state information is current. The method receives from a plurality of clients client messages, each client message including ordering information. For each client message, the method determines whether the ordering information of that client message is consistent with previous ordering information of the state information. The method indicates that the state information is possibly not current when client messages that are determined to be inconsistent satisfy a not current threshold. The method indicates a confidence level associated with the indication. In some embodiments, the not current threshold is based on clients that sent gap client data. In some embodiments, the not current threshold is based on gap client data and not clients that sent gap client data. In some embodiments, the not current threshold is based on a number of clients that sent gap client data and an amount of gap client data.

In some embodiments, a host computing system that provides a secure enclave for execution of an application and for verifying whether application information of the application that is provided to the secure enclave by the host computing system is consistent with received data. The host computing system comprises one or more computer-readable storage mediums for storing computer-executable instructions and one or more processors for executing the computer-executable instructions stored in the one or more computer-readable storage mediums. The instructions control the secure enclave to receive from the host computing system encrypted data that includes ordering information and a related data identifier. The instructions control the secure enclave to decrypt the encrypted data. The instructions control the secure enclave to receive from the host computing system encrypted application information that was previously provided by the secure enclave to the host computing system. The encrypted application information includes previous ordering information that is associated with the related data identifier. The instructions control the secure enclave to decrypt the encrypted application information. The instructions control the secure enclave to determine whether the decrypted application information and the decrypted data are consistent based on the ordering information and the previous ordering information being consistent. In some embodiments, the instructions further for controlling the secure enclave to, when the ordering information and the previous ordering information are consistent, update the decrypted application information with new previous ordering information that is associated with the related data identifier. In some embodiments, the application information includes previous ordering information for each of multiple related data identifiers. In some embodiments, wherein the data is a message and the related data identifier is based on a sender of the message. In some embodiments, the related data identifier is based on a topic associated with the data. In some embodiments, the instructions further for controlling the secure enclave to generate re-encrypted application information by encrypted the decrypted application information and providing the re-encrypted application information to the host computing system so that the host computing system can provide the re-encrypted application information to the secure enclave after a restart of the secure enclave.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/we claim:

1. A method, performed by an application of a secure enclave environment during execution of the application by a host computing system, for persisting state information of the application, the method comprising:
encrypting a state message that includes the state information;
directing the host computing system to send the encrypted state message to the application;
after execution of the application halts and is restarted, receiving from the host computing system the encrypted state message;
decrypting the encrypted state message; and
initializing state information of the executing application to the state information of the decrypted state information.

2. The method of claim 1 wherein the state message includes an application identifier that identifies the application.

3. The method of claim 1, wherein further after a client message is received from a client, determining whether the state information and the client message are consistent based on ordering information of the client message and previous ordering information of the state information.

4. The method of claim 3, wherein the previous ordering information of the state information is maintained for a subset of related message identifiers.

5. The method of claim 1, wherein the state message includes previous ordering information relating to a client and wherein the method further comprises: after restart of execution of the application, receive from the host computing system a client message sent by a client to the application, the message including client ordering information.

6. The method of claim 1, wherein the state message is sent to create a checkpoint for the application.

7. The method of 1 wherein the state message is sent to a client system and the client system then sends a message with the state information to the application.

8. A host computing system for persisting state information of an application of a secure enclave, the host computing system comprising:
one or more computer-readable storage mediums for storing computer-executable instructions for controlling the host computing system to:
encrypt a state message that includes the state information;
direct the host computing system to send the encrypted state message to a client of the application;
after execution of the application halts and is restarted, receive from the host computing system the encrypted state message sent by the client;
decrypt the encrypted state message; and
initialize state information of the executing application to the state information of the decrypted state information; and
one or more processors for executing the computer-executable instructions stored in the one or more computer-readable storage mediums.

9. The host computing of claim 8, wherein the state message includes an application identifier that identifies the application.

10. The host computing system of claim 8, wherein the state message includes previous ordering information relating to the client and wherein the instructions further control the host computing system to after restart of execution of the application, receive from the host computing system a client message sent by the client to the application, the message including client ordering information.

11. The host computing system of claim 10, wherein the instructions further control the host computing system to determine whether the state information and the client message are consistent based on the client ordering information and the previous ordering information.

12. The host computing system of claim 10, wherein the previous ordering information of the state information is maintained for a subset of related message identifiers.

13. The host computing system of claim 10, wherein the state message is sent to create a checkpoint for the application.

14. At least one non-transitory, computer-readable medium carrying instructions, which when executed by at least one data processor, performs operations for persisting state information of an application of a secure enclave environment during execution of the application by a host computing system, the operations comprising:
encrypting a state message that includes the state information;
directing the host computing system to send the encrypted state message to the application;
after execution of the application halts and is restarted, receiving from the host computing system the encrypted state message;
decrypting the encrypted state message; and
initializing state information of the executing application to the state information of the decrypted state information.

15. The at least one non-transitory, computer-readable medium of claim 14, wherein the state message includes an application identifier that identifies the application.

16. The at least one non-transitory, computer-readable medium of claim 14, wherein the state message is sent to a client system and the client system then sends a message with the state information to the application.

17. The at least one non-transitory, computer-readable medium of claim 14, wherein the operations further comprise: further after a client message is received from a client, determining whether the state information and the client message are consistent based on ordering information of the client message and previous ordering information of the state information.

18. The at least one non-transitory, computer-readable medium of claim 17, wherein the previous ordering information of the state information is maintained for a subset of related message identifiers.

19. The at least one non-transitory, computer-readable medium of claim 14, wherein the state message includes previous ordering information relating to a client and wherein the operations further comprise: after restart of execution of the application, receive from the host computing system a client message sent by a client to the application, the message including client ordering information.

20. The at least one non-transitory, computer-readable medium of claim 14, wherein the state message is sent to create a checkpoint for the application.
